(19) United States
(12) Patent Application Publication
(10) Pub. No.: US 2012/0160747 A1
(43) Pub. Date: Jun. 28, 2012

(54) Method and Device for Marking Objects, Particularly Components of a Motor Vehicle, with an Embossed Hologram and Objects Marked in this Way

(75) Inventors: Rolf Thorsten Striebich, Kornwestheim (DE); Michael Fasold, Auenwald (DE)

(73) Assignee: MANN+HUMMEL GMBH, Ludwigsburg (DE)

(21) Appl. No.: 13/384,237

(22) PCT Filed: Jul. 14, 2010
(86) PCT No.: PCT/EP2010/060141

§ 371 Date: Mar. 14, 2012

(30) Foreign Application Priority Data
Jul. 15, 2009 (DE) 10 2009 033504.8

(51) Int. Cl. G03H 1/02; B05D 5/06; B05D 3/02; B01D 35/14; B05C 9/12; B29C 35/08; B32B 37/12; B29C 59/02; B29D 11/00; B32B 38/06

(52) U.S. Cl. 210/85; 264/1.31; 427/162; 427/557; 156/196; 118/102; 425/174.4; 156/443

(57) ABSTRACT

The invention relates to a method and to a device for marking objects, particularly components (10 of a motor vehicle, preferably filter elements, with an embossed hologram (11) and to objects marked in this way. The object (10) to be marked is provided with an embossing region (12) to be embossed in the soft state. An embossing body (14a) is pressed into the soft embossing region (12) such that the embossed hologram (11) emerges from the negative (16) of the embossing body (14a) in the embossing region (12), and the embossing body (14a) is separated from the embossing region (12) after the same has solidified.

### TECHNICAL FIELD

The invention concerns a method for marking objects, in particular components of a motor vehicle, with an embossed hologram.

Furthermore, the invention concerns a device for marking objects, in particular components of a motor vehicle, with an embossed hologram, in particular for performing the method according to the invention.

Moreover, the invention concerns an object, in particular a component of a motor vehicle, preferably a filter element, that is marked with an embossed hologram.

### PRIOR ART

Embossed holograms in the meaning of the invention have surficial relief structures, preferably in the microstructure or nanostructure range. They can be generated in particular by being molded from holographic patterns or other embossing negatives.

It is known to mark objects individually and forgery-safe with such embossed holograms in order to increase brand recognition of the objects. Moreover, such embossed holograms serve as a manufacturer's proof of origin.

It is known in the market to apply hologram stickers to the objects in order to mark them.

The invention has the objective to configure a method and a device of the aforementioned kind such that it can be realized as simply as possible and that it enables a robust, unique and forgery-proof marking of objects.

### SUMMARY OF THE INVENTION

This objective is solved in accordance with the invention in that
the object to be marked is provided with an embossing region that can be embossed in the soft state;
an embossing body is pressed into the soft embossing region such that the embossed hologram is molded from the embossing body in the embossing region and the embossing body, after solidification of the embossing region, is separated from the latter.

According to the invention, an embossing negative of an embossing body is molded in a soft embossing region that is connected, or will be connected, to the object to be marked. Since the embossing region during the embossment process is initially soft, it molds optimally to the embossing negative, even in case of complex structures. After solidification of the embossing region the embossed hologram is robust. In this way, the embossing negative can be designed with very complex, individual and forgery-safe features. With it, the same marking can be applied in a reproducible way on different objects. In this connection, the embossing region can be attached on the object before the actual embossment process or can be formed from softenable regions of the object. However, the embossing region can also be applied to the object during the embossment process, or subsequently. With the method, objects can be provided with an inexpensive, forgery-safe and/or visually pleasing markings enabling also a differentiation with regard to piracy products.

In an advantageous embodiment of the method, the object to be marked can be provided with the embossing region and, subsequently, the embossing body is pressed into the soft embossing region. In this way, the embossing region can be fixedly connected to the object from the start.

Advantageously, for this purpose a certain quantity of soft, in particular liquid, embossing material can be applied as an embossing region onto the object to be marked and the embossing body can be pressed into the still soft embossing region. This has the advantage that no additional working step before the actual embossment process is required in order to soften the embossing region so that also corresponding tools can be eliminated.

As an alternative, advantageously the initially solid embossing region for performing the embossment process can be softened, in particular by hot air or (IR) radiation, and the embossing body can then be pressed into the thus softened embossing region. It is advantageous in this connection that the embossing region is shaped or arranged on the object at a different time than the actual embossment process because the solidification duration during which the embossing body is pressed into the still soft embossing region is not relevant.

Moreover, advantageously an embossing material that is to form the embossing region can be applied onto one side of a perforated wall of the object to be marked which side is opposite to the side where the embossing region is to be arranged later on. For performing the embossment process, the embossing material can be softened so that is passes through the perforated wall to the wall's opposite side and here the embossing body can be pressed in. In this way, the adhesive beads, preferably hot melt adhesives, that are present anyway for gluing the object can be employed as an embossing material for applying the embossed hologram on the side of the object that is visible after the adhesion process. The embossing material can also be applied beforehand, in particular already during manufacture of the object, at a protected location on the object. Moreover, excess embossing material is thus not visible from the exterior; this is visually pleasing. Moreover, in this way there are no disturbing transitions at the exterior side of the object. Incidentally, the perforation is beneficial with respect to the stability of the connection of the embossing region with the object because the solidified embossing material engages mechanically the perforation and with the solidified embossing material is secured on the side of the perforated wall that is opposite the embossed hologram. In this way, combinations of embossing material and material of the object can be used which otherwise are not adhering or only adhering to a limited extent to each other.

Advantageously, the rigid embossing region, in particular a solidified hot melt adhesive strip, can be attached to the object to be marked; at least an embossing side of the embossing region that is facing the embossing body is softened; and, subsequently, the embossing body can be pressed in. The embossing region can thus be simply premanufactured in a desired shape separate from the object to be marked and can be attached to the object prior to the embossment process.

In a further advantageous embodiment of the method, hot melt adhesive, in particular a polyamide-based or polyolefin-based one, can be used as an embossing material for forming the embossing region. Hot melt adhesive can be produced and processed easily. It can be applied simply as a liquid or solid onto the object to be marked. It hardens to a stable form and can be easily softened by means of heating.

In another advantageous embodiment of the method, synthetic fiber media can be applied as an embossing region onto the object to be marked; they can be partially softened, in particular heated by hot air or IR radiation up to the melting point; the embossing body can be pressed into the soft synthetic fiber media and, after solidification of the embossing region, can be separated therefrom. Synthetic fiber media can be connected simply with the object to be marked. They can be softened simply by heating and can then be optimally shaped.

Another advantageous embodiment of the method provides that a softenable embossing region of the object to be marked, particularly of plastic material or a material that is not crosslinked, in particular a housing, a cover, foils, or end disks of filters, is partially softened at the surface, in particular by hot air or IR radiation can be heated up to the melting point; the embossing body can then be pressed into the soft embossing region, and can be separated from the embossing region after solidification of the embossing region. In this way, a separate embossing material is not required. Also, an optimal adhesion of the embossing region on the object is achieved because no material transitions and connecting locations are produced.

In a further advantageous embodiment of the method, the soft embossing region, in particular hot melt adhesive, can be applied to the embossing body and embossed and, after solidification, can be attached to the object to be marked. In particular, a contact surface of the embossing region that is facing the object to be marked may still be adhesive after solidification in order to apply it to the object to be marked. In this way, it is avoided that the embossing material during the embossment process is displaced on the object to be marked. Also, excess quantities of embossing material can be removed in a simple way already from the embossing body. By means of the still adhesive surface, the embossing region can be simply attached to the object.

Advantageously, the contact surface of the already solidified embossing region that is facing the object to be marked, while on the embossment body, can be heated surficially before attachment to the object to be marked, in particular by means of hot air or IR radiation. In this way, adjustment of the time of attachment to the object and the solidification time of the embossing region can be optimized and the quantity of embossing material, in particular of the hot melt adhesive, can be optimized.

Another advantageous embodiment of the method provides that the embossing region is provided in a recess or another kind of depression of the object to be marked. In this way, the connection of the embossing region with the object to be marked can be improved in a simple way and the detachment of the marking can be made significantly more difficult. The connection is thus also improved for objects, in particular metal objects, for example, metal housings, on which the embossing region does not adhere as well as, for example, on paper or plastic material. Moreover, the surfaces of the object and the embossing region can have continuous and seamless transitions into each other; this may be advantageous with respect to a reliable connection.

In a further advantageous embodiment of the method, the embossing body can be provided with the negative of the embossed hologram in particular by means of explosive embossing or a wet-chemical process. Explosive-embossed embossing negatives are optimally forgery-safe because complex structures can be realized with them. Moreover, the structural pattern upon explosive embossing is destroyed so that the process cannot be copied. Even if an identical pattern were used, the complex process of producing the negative of the embossed hologram on the embossing body by means of explosion cannot be repeated in detail.

The embossing body advantageously can be realized as a plunger or a roller. By means of a roller, pressure from the embossing body can be transmitted continuously onto the embossing region. The embossing roller is suitable in particular for an embossment process that is carried out during a continuous movement of the object relative to the embossing body, in particular along a conveying path.

The embossing body in the form of a roller can advantageously be rolled across the embossing region wherein the rotational speed of the roller and the duration of the solidification process of the embossing region can be matched relative to each other such that the embossing area of the embossing body is separated from the embossing region only after solidification of the latter has taken place. In this way, the stability of the embossed hologram is improved and it is prevented that the embossed hologram during or after separation becomes deformed, as can be the case when the embossing region is not completely solidified before separation.

In a further advantageous embodiment of the method, the object to be marked can be moved along a conveying path and the embossing body during the embossment process can travel together with the object, in particular by use of a carriage that moves with the object. In this way, the object can be transported farther while the embossing region solidifies. Thus, a conveyor for the object must not be stopped during the embossment process. This reduces the production time as a whole.

Advantageously, the embossing body can be moved in circulation on a closed path, in particular continuously, wherein the path, at least in a section where the embossment process is performed, extends along the conveying path of the object. In this way, the embossing body after completion of an embossment process can be returned simply to the start of the embossment section of the conveying path for embossing the next object that is transported on the conveying path.

In a further advantageous embodiment of the method, a filter medium can be marked with the embossed hologram. In particular for filter media a forgery-safe quick embossment process is advantageous because, on the one hand, the multitude of filter media available on the market can be differentiated clearly. Moreover, large quantities of filter media can be marked in a simple and efficient way.

The objective is moreover solved by a device with
a unit for providing the object to be marked with an embossing region that can be embossed in the soft state;
an embossing body that can be pushed into the soft embossing region in such a way that the embossed hologram is molded form the negative of the embossing body in the embossing region and the embossing body after solidification of the embossing region can be separated from the latter. The advantages of the device according to the invention corresponds to the aforementioned advantages of the method according to the invention.

Moreover, the objective is solved by the object provided, in the embossing region that can be embossed in the soft state, with the embossed hologram by molding from a negative of an embossing body wherein the embossing body is pressed into the soft embossing region and after solidification of the embossing region is separated from the latter. The advantages of the object according to the invention corresponds also to the aforementioned advantages of the method according to the invention.

### BRIEF DESCRIPTION OF THE DRAWINGS

Further advantages, features and details of the invention can be taken from the following description in which embodiments of the invention will be explained in more detail with the aid of the drawing. A person of skill in the art will expediently consider the features disclosed in combination in the drawing, the description, and the claims also individually and will combine them to other meaningful combinations. It is shown in:

FIGS. 1 to 5 schematically a first embodiment of a method and of a device for marking a component of a motor vehicle by means of an embossed hologram;

FIGS. 6 to 10 schematically a second embodiment method and a device for marking a component similar to the method/the device of the FIGS. 1 to 5;

FIGS. 11 to 12 schematically a third embodiment of a method and a device for marking a component similar to the methods/devices of the FIGS. 1 to 10;

FIGS. 13 to 15 schematically a fourth embodiment of a method and device for marking a component similar to the methods/devices of the FIGS. 1 to 12;

FIGS. 16 to 20 schematically a fifth embodiment of a method and a device for marking a component similar to the methods/devices of the FIGS. 1 to 15;

FIGS. 21 to 25 schematically a sixth embodiment of a method and a device for marking a component similar to the methods/devices of the FIGS. 1 to 20;

FIGS. 26 to 29 schematically a seventh embodiment of a method and a device for marking a component similar to the methods/devices of the FIGS. 1 to 25;

FIGS. 30 to 34 schematically an eighth embodiment of a method and a device for marking a component similar to the methods/devices of the FIGS. 1 to 29;

FIGS. 35 to 38 schematically a ninth embodiment of a method and a device for marking a component similar to the methods/devices of the FIGS. 1 to 34;

FIGS. 39 to 44 schematically a tenth embodiment of a method and a device for marking a component similar to the methods/devices of FIGS. 1 to 38;

FIGS. 45 to 46 schematically an eleventh embodiment of a method and a device for marking a component similar to the methods/devices of FIGS. 1 to 44.

In the Figures the same components are provided with same reference characters.

### EMBODIMENTS OF THE INVENTION

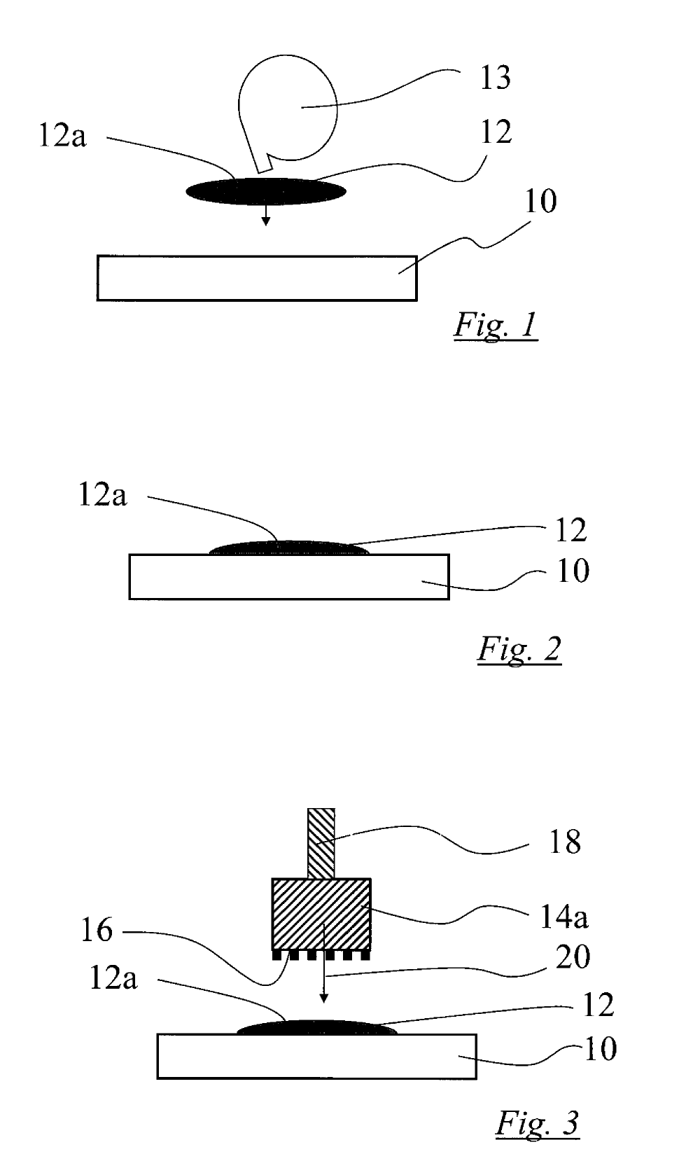

In the FIGS. 1 to 5 a first embodiment of a method and a device for marking components 10 of a motor vehicle with an embossed hologram 11 illustrated in the FIG. 5. Such components can be, for example, filter media, housings, covers, foils, end disks or other parts of filters or filter elements.

First, the component 10 to be marked is provided with an embossing region 12 that can be embossed in the soft state. For this purpose, a certain quantity of liquid hot melt adhesive 12a, for example, a polyamide-based or polyolefin-based one, is applied by means of a dispenser 13 as an embossing region 12 onto the component 10 to be marked (FIGS. 1 and 2).

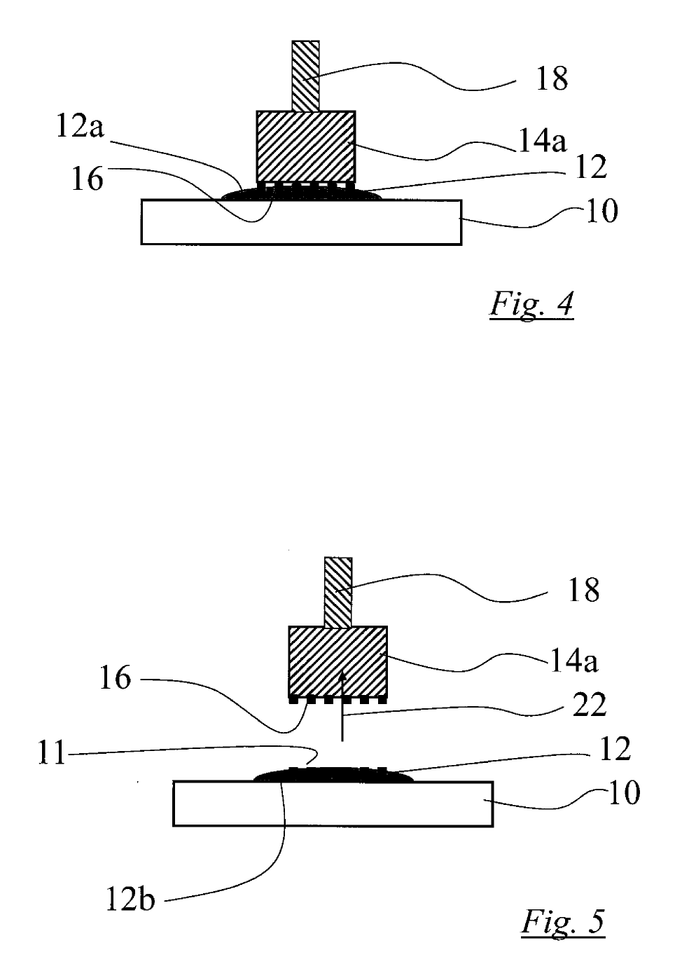

An embossing plunger 14a illustrated in FIGS. 3 to 5 is provided by means of explosive embossing or a wet-chemical process with a surface relief structure in the macrostructure or nanostructure range as a negative 16 for the embossed hologram 11. The embossing plunger 14a is pressed by means of a lifting and lowering device 18 in the direction of arrow 20 into the soft embossing region 12 in such a way that the embossed hologram 11 is embossed from a negative 16 in the embossing region 12 (FIGS. 3 and 4).

After solidification of the embossing region 12 the embossing plunger 14a is separated by means of the lifting and lowering device 18 in the direction of arrow 22 from the solidified hot melt adhesive 12b (FIG. 5).

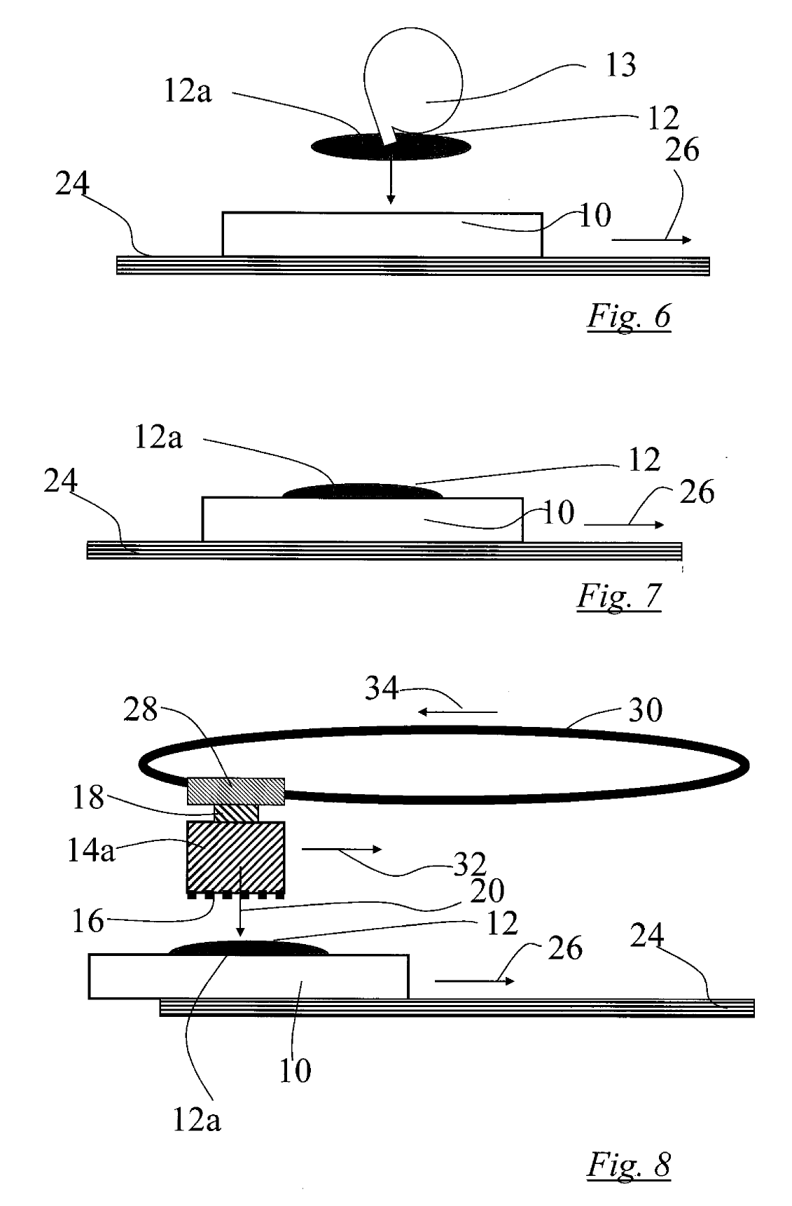

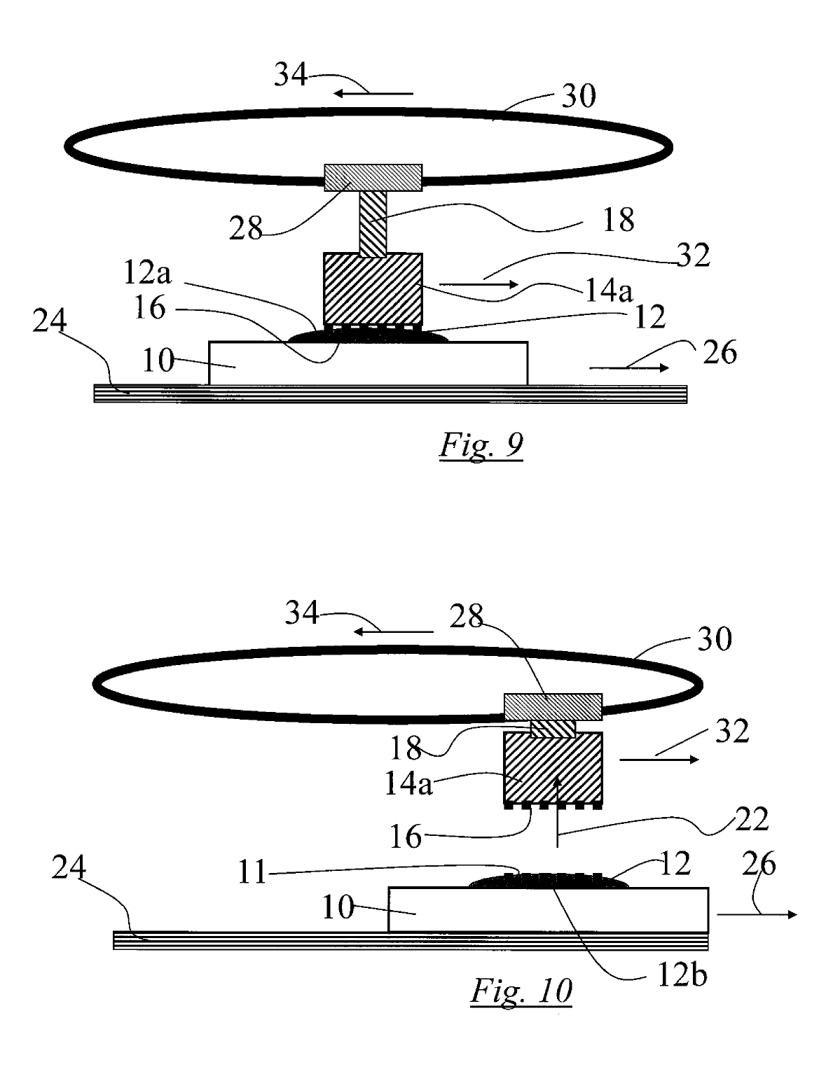

In a second embodiment illustrated in FIGS. 6 to 10, those elements that are similar to those of the first embodiment disclosed in FIGS. 1 to 5 are provided with the same reference characters so that, with respect to their description, reference is being had to the explanations of the first embodiment. The second embodiment differs from the first in that the component 10 to be marked is transported continuously on a conveying belt 24 or by means of a different suitable device along a conveying path in the direction of arrow 26. The component 10 can also be moved in a timed fashion. In FIGS. 6 and 7 sections of the conveying belt 24 are shown which in conveying direction 26 are positioned in front of the section (embossing section) of the conveying belt 24 where the embossment process is performed and that is illustrated in FIGS. 8 to 10.

The embossing plunger 14a is movable by means of the lifting and lowering device 18 on a carriage 28 along a closed path 30 in the direction of arrow 32 as illustrated in FIGS. 8 to 10. The path 30 extends in the embossing section of the conveying belt 24 along the conveying path of the component 10. The carriage 28 with the embossing plunger 14a moves during the embossment process, i.e., from the time of impression into the liquid hot melt adhesive 12a of the embossing region 12 (FIG. 8) up to the point of removal from the solidified hot melt adhesive 12b of the embossing region 12 (FIG. 10), together with the component 10. Therefore, the conveying belt 24 must not be stopped during the embossment process. The conveying speed and the length of the embossing section are selected such that the hot melt adhesive 12a has sufficient time in order to solidify such that the embossed hologram 11 is stably retained. After separation from the component 10 at the end of the embossing section, the carriage 28 with the embossing plunger 14a returns on the path 30 in the direction of arrow 34 back to the beginning of the embossing section in order to mark in the same way with an embossed hologram the next component 10 (not shown in the Figures) on the conveying belt 24. In this way, a plurality of components can be marked in a continuous way.

The path 30 and the conveying belt 24 can also be converging in the conveying direction 26 in front of the embossing section and subsequent thereto can diverge so that the embossing plunger 14a at the beginning of the embossing section is pressed automatically into the embossing region 12 and, downstream of the embossing section, the embossing plunger 14a and the solidified embossing region 12 are automatically separated from each other. In this way, the separate lifting and lowering device 18 for the embossing plunger 14a on the carriage 28 is not needed.

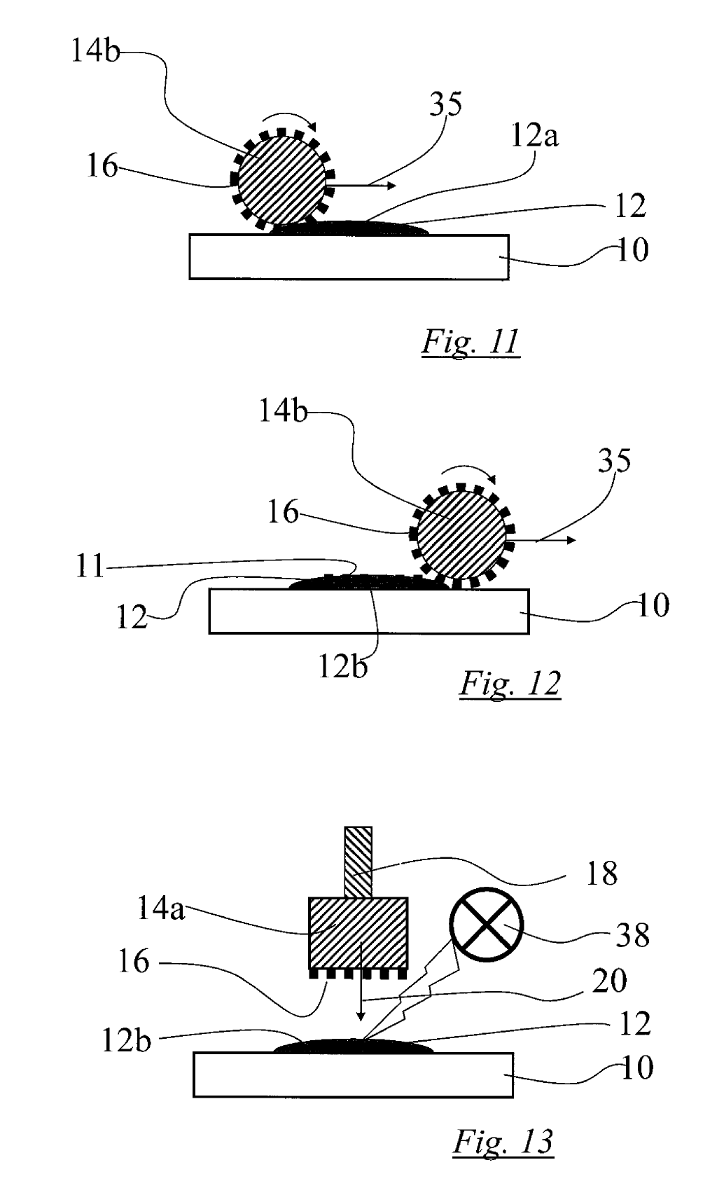

A third embodiment, illustrated in FIGS. 11 and 12, differs from the first embodiment disclosed in FIGS. 1 to 5 in that the embossing body is realized as an embossing roller 14b. The negative 16 of the embossed hologram 11 is located on the circumference of the embossing roller 14b. Instead of extending across the entire circumference, as shown, the negative of the embossing hologram can also be arranged only on parts of the circumference on the embossing roller 14b. The application of the embossing region 12 in the form of liquid hot melt adhesive 12a onto the component 10 is realized in analogy to the first embodiment and is therefore not again illustrated here in order to simplify matters.

The embossing roller 14b is rolled in the direction of arrow 35 across the embossing region 12. The rotational speed of the embossing roller 14b and the duration of the solidification process of the embossing region 12 are matched to each other such that the respective embossing area of the embossing roller 14b is separated from the embossing region 12 only after solidification of the latter.

A fourth embodiment illustrated in FIGS. 13 to 15 differs from the first embodiment illustrated in FIGS. 1 to 5 in that the embossing region 12 is formed of an already solidified hot melt adhesive strip 12b. For this purpose, the hot melt adhesive strip 12b can be attached in the solidified state onto the component 10. Alternatively, liquid hot melt adhesive 12a can be applied onto the component 10 and solidifies thereon before the actual embossment process.

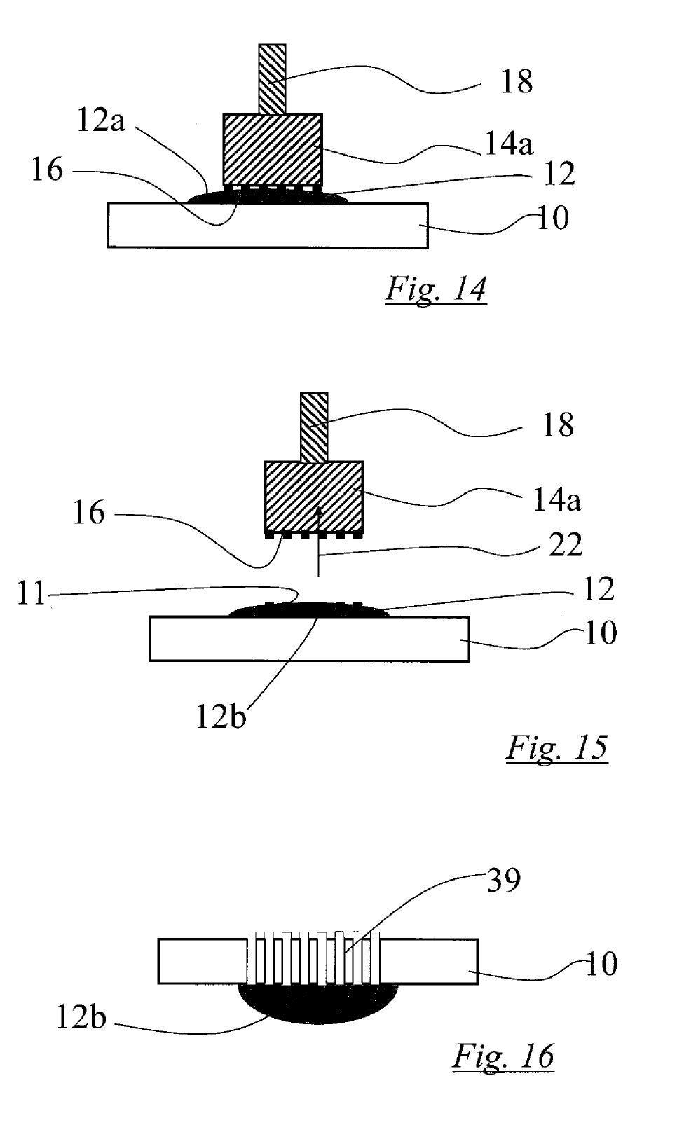

For performing the embossment process, the solidified embossing region 12 is heated by means of infrared (IR) radiation device 38 and softened in this way (FIG. 13). It is sufficient here when an embossing side of the embossing region 12 that is facing the embossing plunger 14a is softened. However, the entire hot melt adhesive strip 12b can be softened also. The embossing plunger 14a is then pressed into the thus softened hot melt adhesive 12a of the embossing region 12 (FIG. 14). After solidification of the embossing region 12 the embossing plunger 14a is separated from the embossing region 12 (FIG. 15).

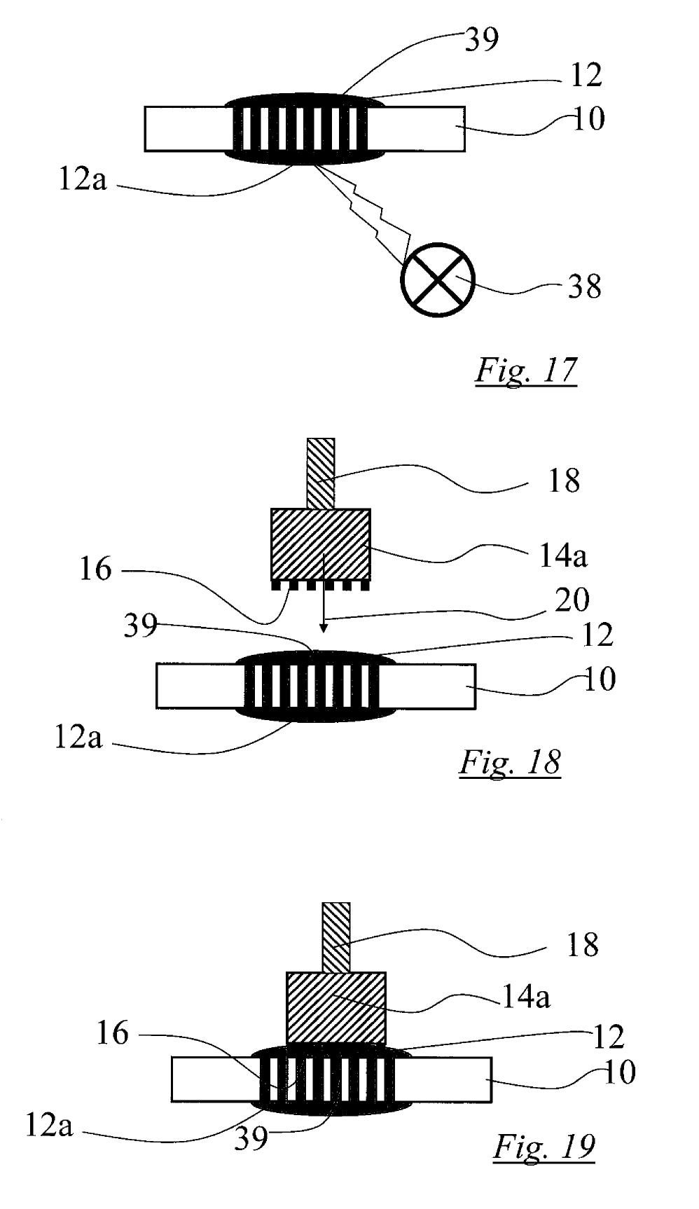

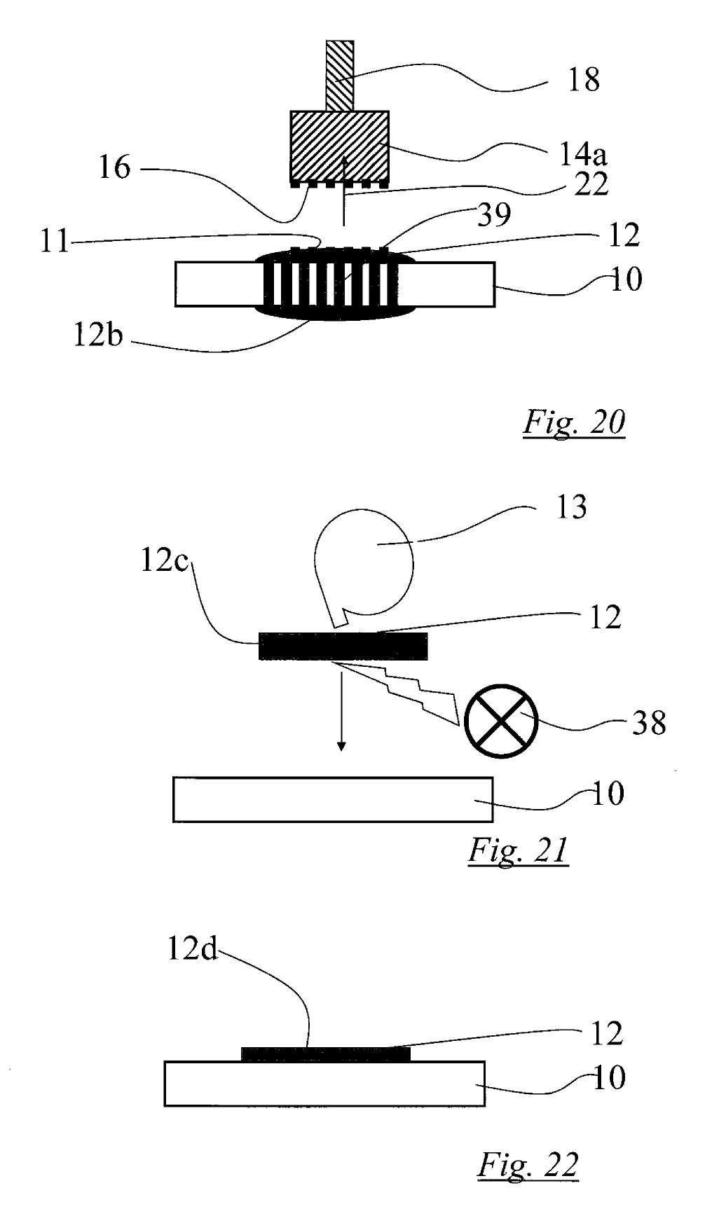

A fifth embodiment, illustrated in FIGS. 16 to 20, differs from the fourth embodiment illustrated in FIGS. 13 to 15 in that a wall of the component 10 is provided with a perforation 39. The solidified hot melt adhesive strip 12b is applied onto one side of the perforated wall of the component 10 to be marked which side is opposite the side where the embossing region 12 is to be arranged later on (FIG. 16). For example, the hot melt adhesive strip 12b can be a glue bead that is present anyway for gluing the component 10. The hot melt adhesive strip 12 is heated for performing the embossment process by means of the IR radiation device 38 and softened such that the soft hot melt adhesive 12a passes through the perforated wall to the wall's opposite side and forms thereat the embossing region 12 (FIG. 17). Here, the embossing plunger 14a, as in the first, second and fourth embodiment, is pressed into the soft embossing region 12a (FIG. 19). After solidification of the embossing region 12b, the embossing plunger 14a is separated from the embossing region 12 (FIG. 20).

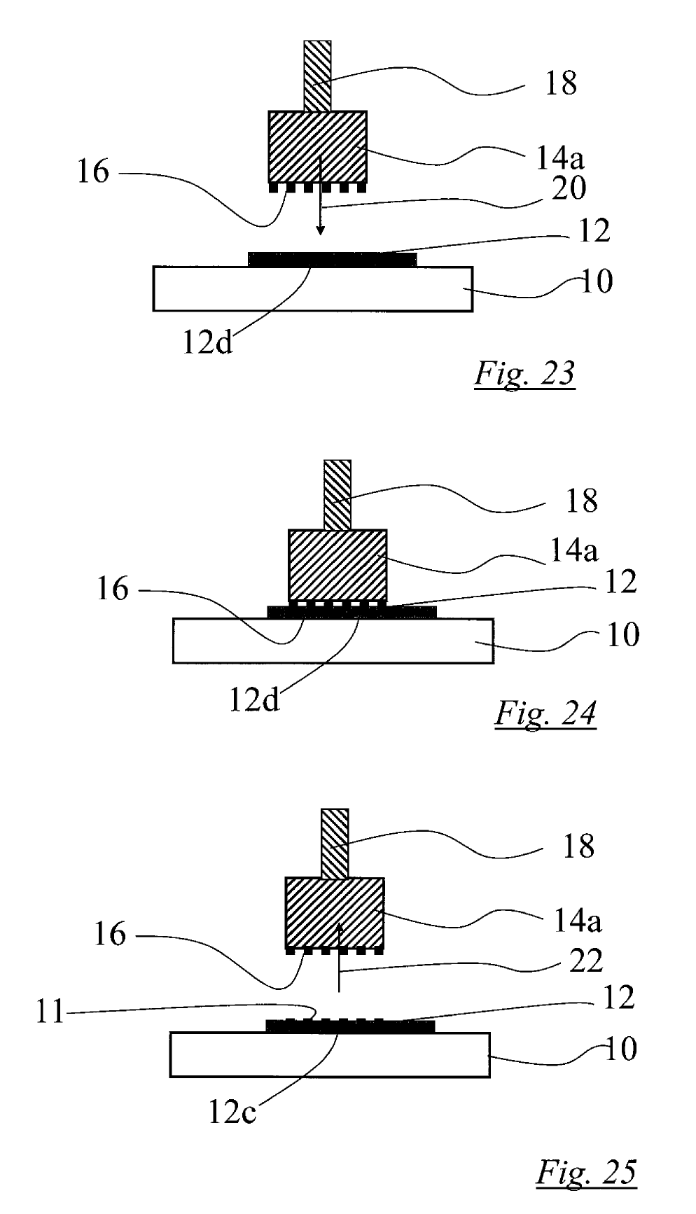

A sixth embodiment, illustrated in FIGS. 21 to 25, differs from the first embodiment illustrated in FIGS. 1 to 5 in that, instead of the hot melt adhesive 12a, 12b, synthetic fiber media 12c are applied as embossing region 12 onto the component 10. By means of IR radiation device 38, the synthetic fiber media 12c are partially heated up to the melting point and softened (FIG. 21) and, as with the liquid hot melt adhesive 12a in the first embodiment, applied onto a component 10 (FIG. 22). The embossing plunger 14a is pressed into the soft synthetic fiber media 12d of the embossing region 12 (FIGS. 23 and 24). After solidification of the embossing region 12, the embossing plunger 14a is separated from the embossing region 12 (FIG. 25).

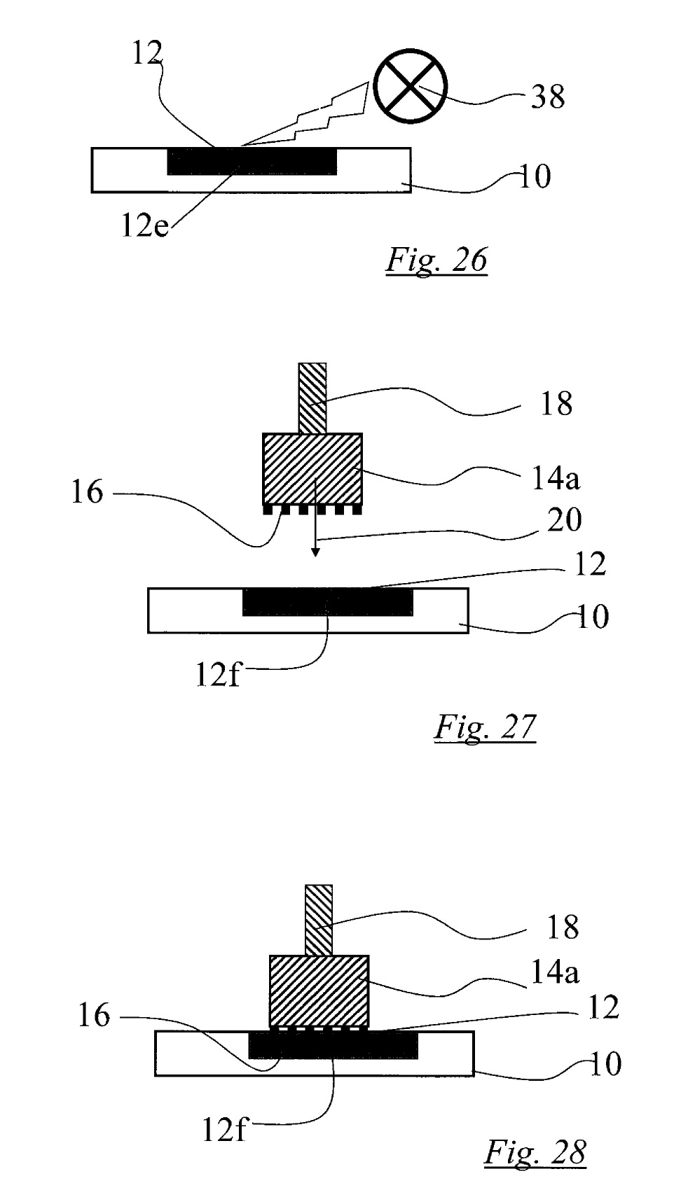

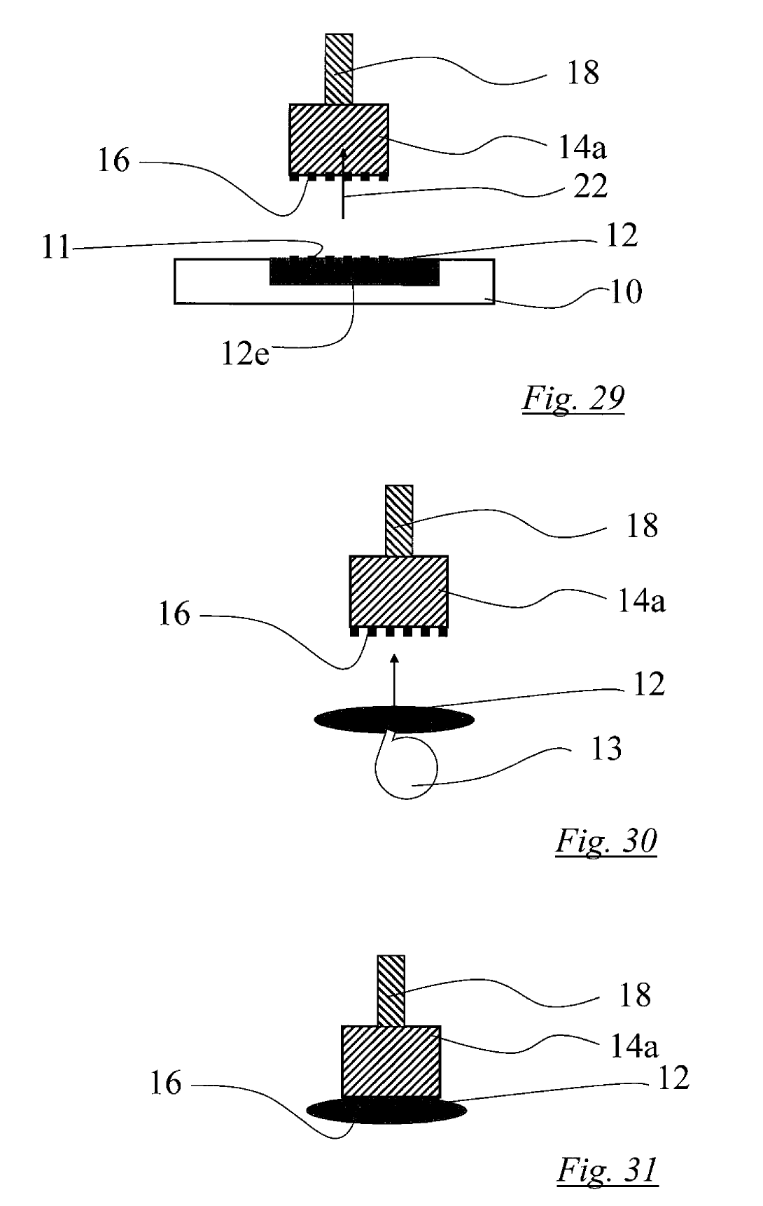

A seventh embodiment, illustrated in FIGS. 26 to 29, differs from the first embodiment disclosed in FIGS. 1 to 5 in that no separate embossing material such as, for example, the hot melt adhesive or synthetic fiber media, are used in order to realize the embossing region 12. Instead, the component 10 is provided with an embossing region 12 in that an existing region 12 of the component 10 that can be softened as a result of the material properties of the component 10 to be marked is partially heated at the surface to the melting point by means of IR radiation device 38 and is softened in this way (FIG. 26). The component 10, or at least the embossing region 12, can be, for example, of plastic material or a material that is not crosslinked. The embossing plunger 14a is pressed into the soft area 12f of the embossing region 12 (FIGS. 27 and 28) and after solidification of the embossing region 12 is separated from the latter (FIG. 29).

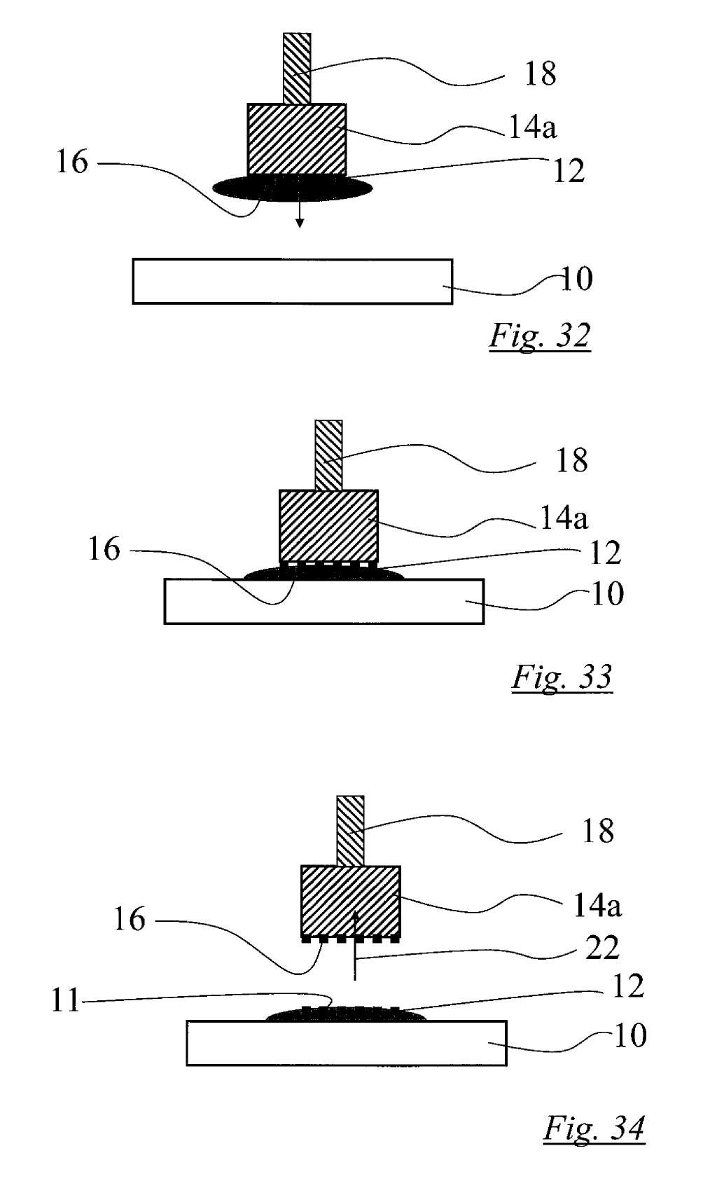

An eighth embodiment, illustrated in FIGS. 30 to 34, differs from the first embodiment disclosed in FIGS. 1 to 5 in that the soft embossing material that is to form the embossing region 12, for example, the hot melt adhesive or the softened synthetic fiber media, is applied onto the embossing plunger 14a (FIG. 30) and solidifies thereat (FIG. 31). After solidification, a contact surface of the embossing region 12 that is facing the component 10 to be marked is still adhesive for application on the component 10 to be marked. The solidified embossing region 12 is applied onto the component 10 to be marked (FIGS. 32 and 33) and the embossing plunger 14a can be directly separated from the embossing region 12 (FIG. 34) because the embossing region 12 is already solidified.

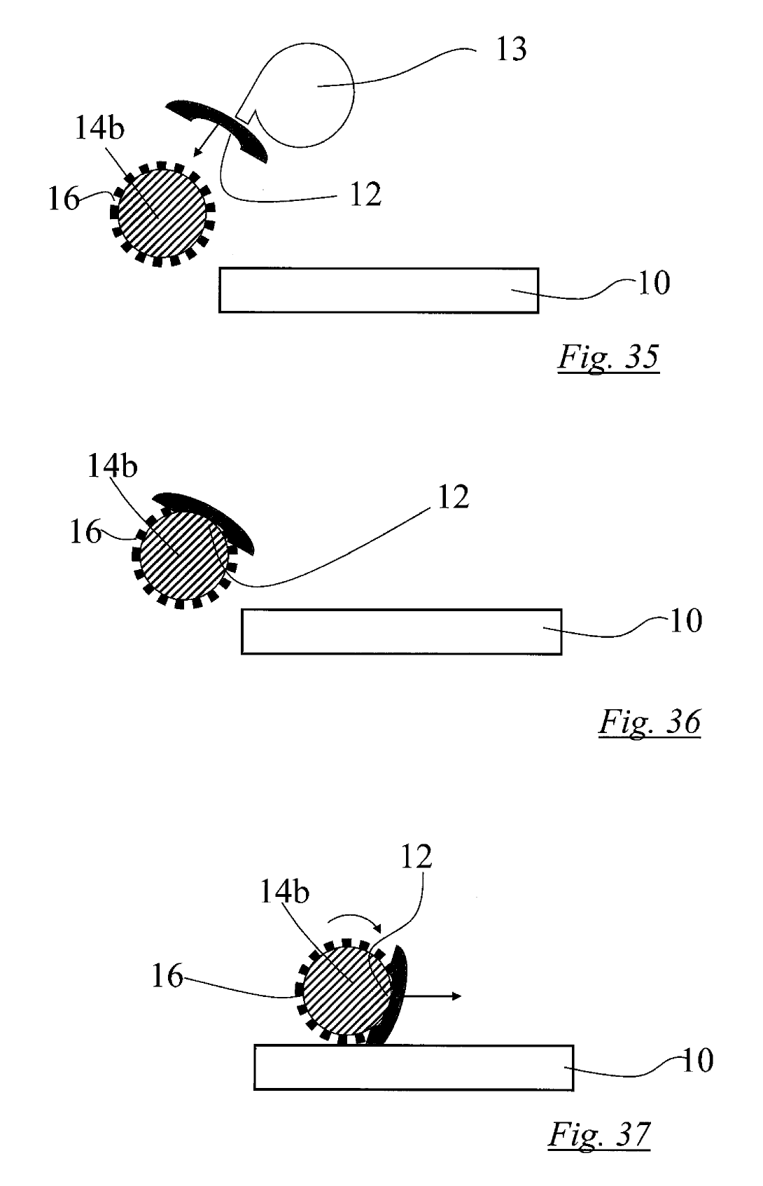

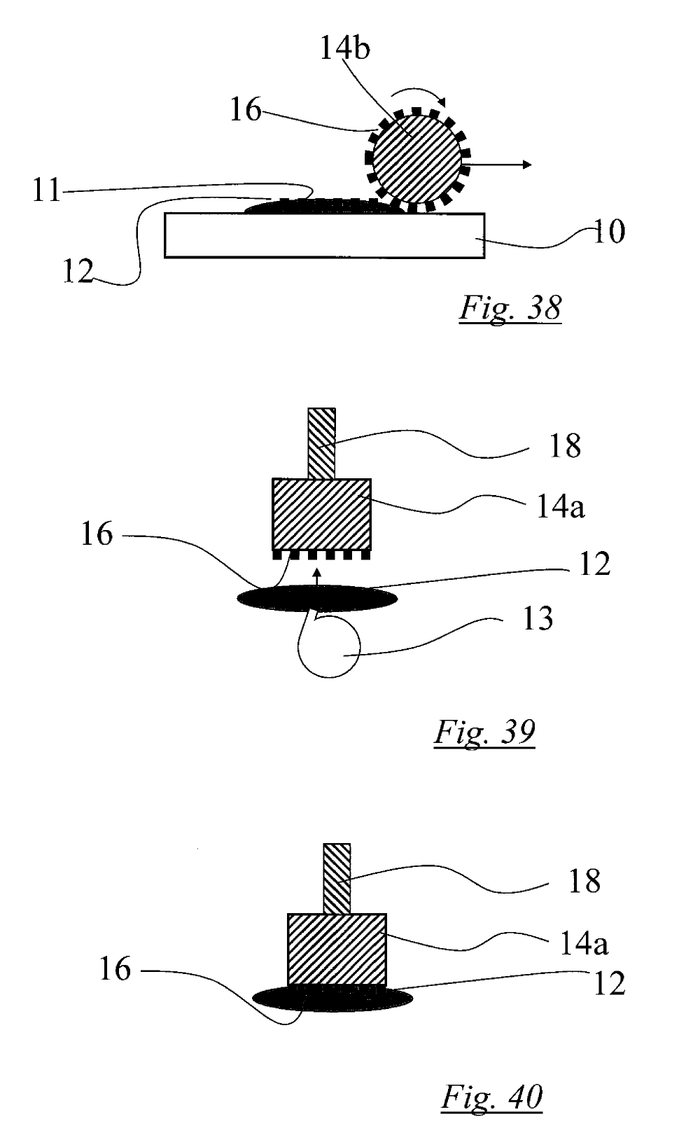

A ninth embodiment, illustrated in FIGS. 35 to 38, differs from the eighth embodiment illustrated in FIGS. 30 to 34 in that instead of the embossing plunger 14a the embossing roller 14b is used that is rolled for application of the embossing region 12 on the component 10 across the component's surface (FIGS. 37 and 38).

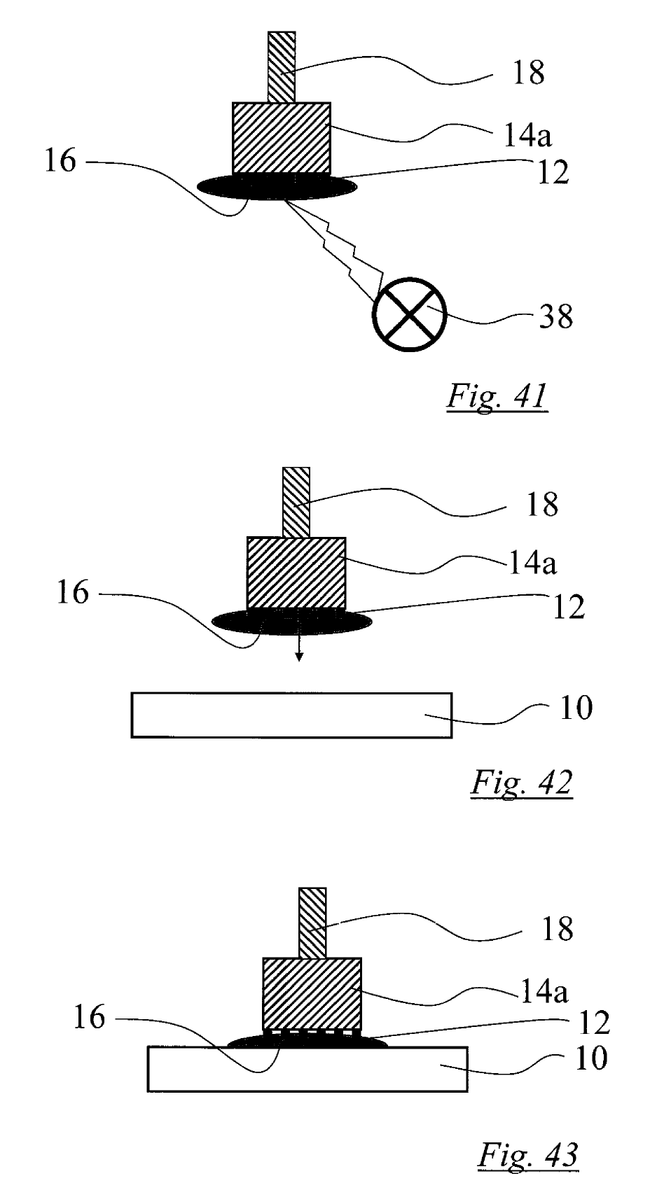

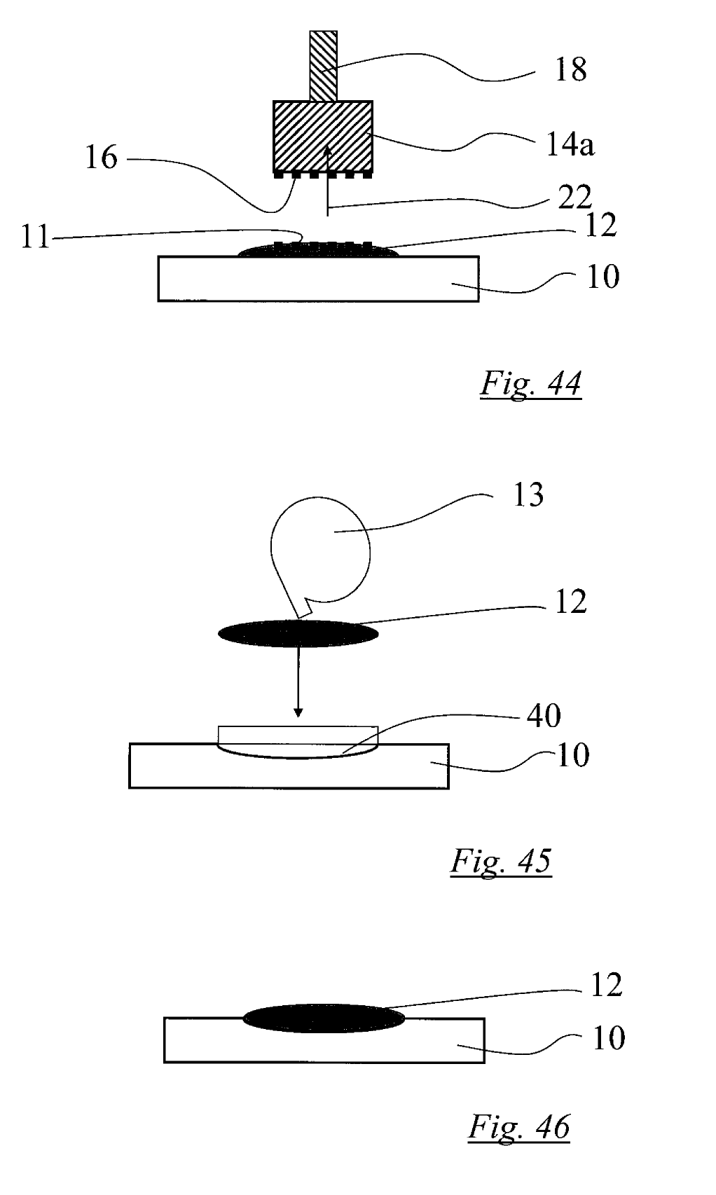

A tenth embodiment, illustrated in FIGS. 39 to 44, differs from the eighth embodiment illustrated in FIGS. 30 to 34 in that on the embossing plunger 14a the contact surface of the already solidified embossing region 12 that is facing the component 10 to be marked is surficially heated by means of IR radiation device 38 (FIG. 41) before application to the component 10 and in this way its adhesive action is improved.

An eleventh embodiment, illustrated in FIGS. 45 and 46, differs from the first embodiment disclosed in FIGS. 1 to 5 in that the embossing region 12 is introduced into a recess 40 of the component 10 to be marked. Instead of the recess 40 also a different kind of depression can be provided. Such a recess 40 or depression can be used also in the other embodiments.

In all of the above described embodiments of a method and a device for marking components 10 by means of an embossed hologram 11, the following modifications are possible inter alia.

The invention is not limited to marking components 10 of a motor vehicle. Rather, they can also be used for marking objects of different kinds.

The negative 16 of the embossed hologram 11 can also be produced by a different physical and/or chemical method.

Instead of hot melt adhesive 12a, 12b based on polyamide or polyolefin or synthetic fiber media 12c, 12d, it is also possible to use a different kind of embossing material as an embossing region 12 that is initially soft or softenable and, in the soft state, can be embossed and, in the solidified state, retains the embossed hologram 11. In the afore described methods and devices, where expedient, it is possible to use synthetic fiber media 12c, 12d instead of hot melt adhesives 12a, 12b, and vice versa.

Instead of the IR radiation device 38, a hot air blower or another heat source can be used also for softening the embossing region 12.

1.-20. (canceled)

21. A method for marking a component object (10) of a motor vehicle with an embossed hologram (11), comprising:
providing said object to be marked (10);
providing an embossing body (14a; 14b) having a surface relief structure as a negative of said embossed hologram (11);
providing an embossing region (12) that can be embossed when in a soft moldable embossable state;
pressing said surface relief structure of said embossing body (14a; 14b) into said embossing region (12), embossing said embossing region;
molding said hologram (11) into said soft embossing region (12);
solidifying said embossing region (12) with said hologram fixed therein; and
separating said embossing body (14a; 14b) from said embossing region leaving said hologram embossed in said embossing region.

22. The method according to claim 21, wherein
in the step of providing an embossing region, said embossing region (12) is provided on said embossing body; and
wherein said pressing step is practiced after said embossing region (12) is provided on said object to be marked (10) and while said embossing region is in a moldable embossable state.

23. The method according to claim 21, wherein
the step of providing an embossing region (12) is practiced by
providing a quantity of liquid embossing material (12a; 12c); and
applying said liquid embossing material (12a; 12c) onto said object to be marked (10) as said embossing region (12).

24. The method according to claim 21, wherein
the step of providing an embossing region is practiced by
providing an initially solid or rigid embossing region (12b; 12d); and
softening said rigid embossing region (12b; 12d) by heating said rigid embossing region (12b; 12d) by hot air or IR radiation (38) to put it into a moldable embossable state.

25. The method according to claim 21, wherein
in the step of providing said object to be marked, said object has a perforated wall with perforations extending through said object between opposing sides of said object; and
the step of providing a soft embossing region is practiced by
providing an embossing material;
applying said embossing material onto a first one of said side of said object;
softening said embossing material by heating said embossing material (12b; 12d) by hot air or IR radiation (38);
passing a portion of said embossing material through said perforations of said object from said first side to an opposing second side of said object; and
forming said embossing region on said second side of said object by said embossing material passing through said perforations.

26. The method according to claim 21, wherein
the step of providing a soft embossing region is practiced by
providing a solidified hot melt adhesive strip (12b); and
softening at least a side of the said hot melt adhesive strip facing said embossing body by heating said adhesive strip (12b; 12d) by hot air or IR radiation (38) such that such strip is in a moldable embossable state.

27. The method according to claim 21, wherein
in the step of providing an embossing region, said embossing region has an embossing material of a hot melt adhesive (12a, 12b),
wherein said hot melt adhesive (12a, 12b) is polyamide-based or polyolefin-based.

28. The method according to claim 21, wherein
the step of providing an embossing region is practiced by
applying a synthetic fiber media (12c) onto said embossing region (12) of said object (10) to be marked;
softening said synthetic fiber media up to a melting point of said synthetic fiber media, said softening by heating said synthetic fiber media by hot air or IR radiation (38) to put in a moldable or embossable state; and
wherein said pressing said surface relief structure step practiced by
pressing said surface relief structure of said embossing body (14a; 14b) into synthetic fiber media on said soft embossing region (12);
wherein said separating step includes separating said embossing body (14a; 14b) from said synthetic fiber media.

29. The method according to claim 21, wherein
in the step of providing said object to be marked (10), said object is a housing, a cover, foils, or end disks of filter elements, wherein said object is of plastic material or a material that is not crosslinked;
wherein in said step of providing an embossing region (12), said embossing region is a softenable region of said object to be marked;
wherein said step of wherein in said step of providing an embossing region (12) includes
softening said embossing region at an embossing surface by heating said embossing region by hot air or IR radiation up to a melting point of said embossing region to put into a moldable embossable state.

30. The method according to claim 21, wherein
in said step of providing an embossing region (12), said embossing region is a hot melt adhesive separate from said object to be marked, wherein said hot melt adhesive is heated to its melting point to soften for embossing;
wherein in said pressing step, said hot melt adhesive is applied onto said surface relief structure and embossed;
wherein after said solidification step a contact surface side of said embossing region is still soft and adhesive for securing to said object to be marked;
wherein said solidification step, said method further includes
applying said contact surface of said hot melt adhesive onto said embossing region of said object to be marked;
securing said hot melt adhesive onto said object to be marked by solidification of said contact surface.

31. The method according to claim 30, wherein
in said step of providing an embossing body, said embossing body is an embossing roller having at least one surface relief structure;
wherein before said step of applying said contact surface, said method further includes
surficially heating said contact surface by means of hot air or IR radiation to soften said contact surface for adhesion.

32. The method according to claim 21, wherein
in said providing an embossing region step, said embossing region (12) is arranged in a recess (40) or another depression of the object (10) to be marked.

33. The method according to claim 21, wherein
in the step of providing an embossing body, the embossing body (14a; 14b) is provided with the negative (16) of the embossed hologram (11) by explosive embossing or a wet-chemical process.

34. The method according to claim 21, wherein
in the step of providing an embossing body, the embossing body is realized as a plunger (14a) or a roller (14b).

35. The method according to claim 21, wherein
in the step of providing an embossing body, the embossing body is realized as a roller;
wherein in said pressing step is practiced by
rolling said roller (14b) across said embossing region (12);
matching rotational speed of said roller to duration time of solidification of said embossing region such that said separating step is practiced only after solidification of the embossing region (12).

36. The method according to claim 21, wherein
said pressing step is practiced by
providing a carriage on which said embossing body is mounted;
moving said object to be marked along a conveying path (24);
during embossing portion of said pressing step, moving said carriage together with said object to be marked so said embossing body moves in unison with said object to be marked.

37. The method according to claim 36, wherein
in said moving a carriage step, said embossing body (14a) is continuously moved on a closed path (30) that extends, at least with one section in which the embossment process is performed, along the conveying path (24) for the object (10).

38. The method according to claim 21, wherein
in the step providing said object to be marked, the object is a filter medium;
wherein in the molding step, the filter medium is marked with the embossed hologram (11).

39. A device for marking filter elements with an embossed hologram (11) using the method of claim 21, comprising
a hot melt dispenser (13) or an infrared radiation device (38) providing said object to be marked with a embossing region that can be embossed in a soft state;
an embossing body (14a; 14b) that can be pressed into the soft embossing region (12) such that an embossed hologram (11) is molded from the negative (16) of the embossing body (14a; 14b) into the embossing region (12),
wherein the embossing body (14a; 14b) after solidification of the embossing region (12) is separated from the embossing region.

40. A filter element marked with an embossed hologram (11) according to the device of claim 39, wherein
said object to be marked is a filter element of a motor vehicle;
wherein said embossed hologram is molded from said negative of said embossing body in an embossing region that can be embossed in a soft state,
wherein said embossing body contacts into said embossing region,
wherein after solidification of said embossing region, said embossing body is separated from said embossing region.
